(19) United States
(12) Patent Application Publication
(10) Pub. No.: US 2014/0365508 A1
(43) Pub. Date: Dec. 11, 2014

(54) SYSTEMS AND METHODS FOR SCORING GEOGRAPHIC LOCATIONS AND FOR PROVIDING RELATED SEARCHING TOOLS

(71) Applicant: Rental Roost Inc., Pleasanton, CA (US)

(72) Inventors: Nitin Shingate, Pleasanton, CA (US); Vikram Raghavan, Pleasanton, CA (US)

(21) Appl. No.: 14/301,252

(22) Filed: Jun. 10, 2014

Related U.S. Application Data
(60) Provisional application No. 61/833,086, filed on Jun. 10, 2013.

(51) Int. Cl. G06F 17/30

(52) U.S. Cl. CPC G06F 17/30241; G06F 17/3053
USPC 707/748

(57) ABSTRACT

Systems and methods for scoring geographic locations and for providing related searching tools are disclosed herein. According to an aspect, a method includes receiving one or more property identifiers. The method also includes receiving geographic attributes for the one or more property identifiers. Further, the method includes assigning, for each of the one or more property identifiers, a weighting to each geographic attribute based on a distance of a property associated with the property identifier from a location of the geographic attribute. Further, the method includes assigning, for each of the one or more property identifiers, a score to the property identifier based on one or more weightings to the geographic attributes for the property identifier.

### CROSS REFERENCE TO RELATED APPLICATION

This application claims the benefit of and priority to U.S. Provisional Patent Application No. 61/833,086, filed Jun. 10, 2013 and titled SYSTEMS AND METHODS FOR SCORING GEOGRAPHIC LOCATIONS AND FOR PROVIDING RELATED SEARCHING TOOLS, the disclosure of which is incorporated herein by reference in its entirety.

### TECHNICAL FIELD

The present disclosure relates to network-based searching. More particularly, the present disclosure relates to systems and methods for scoring geographic locations and for providing related searching tools.

### BACKGROUND

The Internet has been populated with a variety of searching tools. Particularly, various websites provide users with tools for searching properties available for sale or rent. An example is the search website REALTOR.COM® made available by the National Association of Realtors. Such websites allow users to filter properties based on costs and location. However, there is a need to provide users with the ability to better direct their searches of properties based on their interests.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Systems and methods for scoring geographic locations and for providing related searching tools are disclosed herein. According to an aspect, a method includes receiving one or more property identifiers. The method also includes receiving geographic attributes for the one or more property identifiers. Further, the method includes assigning, for each of the one or more property identifiers, a weighting to each geographic attribute based on a distance of a property associated with the property identifier from a location of the geographic attribute. Further, the method includes assigning, for each of the one or more property identifiers, a score to the property identifier based on one or more weightings to the geographic attributes for the property identifier.

### BRIEF DESCRIPTION OF THE DRAWINGS

The foregoing summary, as well as the following detailed description of various embodiments, is better understood when read in conjunction with the appended drawings. For the purposes of illustration, there is shown in the drawings exemplary embodiments; however, the presently disclosed subject matter is not limited to the specific methods and instrumentalities disclosed. In the drawings:

FIG. 1 is a block diagram of a system for scoring geographic locations and for providing related searching tools in accordance with embodiments of the present invention;

FIG. 2 is a flowchart of an example method for processing modifiable files grouped into themed directories for presentation of web contents in accordance with embodiments of the present invention;

FIGS. 3A and 3B illustrate a flowchart of an example method for organizing a database in accordance with embodiments of the presently disclosed subject matter; and

FIGS. 4 and 5 illustrate screen displays showing example information and images corresponding to a property identifier in accordance with embodiments of the present subject matter.

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

In accordance with embodiments, the presently disclosed subject matter may be implemented on one or more servers or other computing devices connected to the Internet or other communications network. Computing devices, such as laptop computers, desktop computers, and smartphones, may be operable to connect to the one or more servers via the Internet, for example. In an example, a server may receive one or more property identifiers. For example, property identifiers may be stored in a database and associated with houses, condominiums, townhouses, apartments, commercial properties, and the like. Further, the server may receive geographic attributes for the property identifiers. Example geographic attributes include, but are not limited to, shopping amenities, dining amenities, children amenities, family amenities, pet amenities, art-culture amenities, healthcare amenities, enrichment amenities, and the like. Further, the server may assign, for each of the property identifiers, a weighting to each geographic attribute based on a distance of a property associated with the property identifier from a location of the geographic attribute. Further, the server may assign, for each of the property identifiers, a score to the property identifier based on one or more weightings to the geographic attributes for the property identifier. Further, the server may receive an inquiry from a user of a computing device for one of the property identifiers. In response to receipt of the inquiry, the server may present to the user, the score associated with the property identifier. The Internet may be used to receive the inquiry and to present the score to the user.

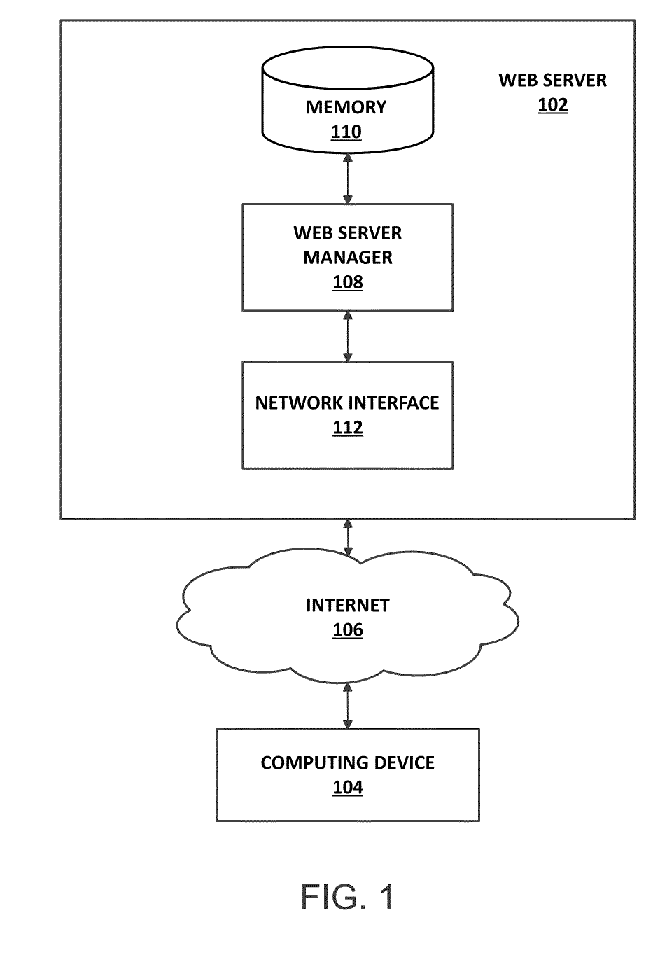

The presently disclosed invention is now described in more detail. For example, FIG. 1 illustrates a block diagram of a system for scoring geographic locations and for providing related searching tools in accordance with embodiments of the present invention. Referring to FIG. 1, the system includes a web server 102 and a client computing device 104 communicatively connected together via the Internet 106. The web server 102 is configured to operate within a WWW environment for providing web pages or interlinked hypertext documents, or other web content, to clients, such as client computing device 104, via the Internet 106. The web server 102 may be one of multiple servers operating in a server farm. The client computing device 104 may be configured with a web browser with which one can view web content, such as web pages containing text, images, video, and/or other multimedia. Further, one can use the web browser to navigate between web pages via hyperlinks or other navigation tools.

The web server 102 may be any suitable computing device having hardware, software, firmware, or combinations thereof configured to deliver web content, such as web pages, that can be accessed through the Internet 106. The web server 102 may include a web server manager 108 for implementing the functions described herein. As an example, the web server manager 108 may be implemented by one or more processors (not shown) and memory 110. Further, the web server 102 may include a network interface 112 for communicating with the Internet 106. The web server 102 may also include a user interface 109, such as a keyboard, display, mouse, and/or other devices for interfacing with a user. Further, for example, a user of the web server 102 may interface by use of another computing device. The functions disclosed herein can be implemented by the web server manager 108.

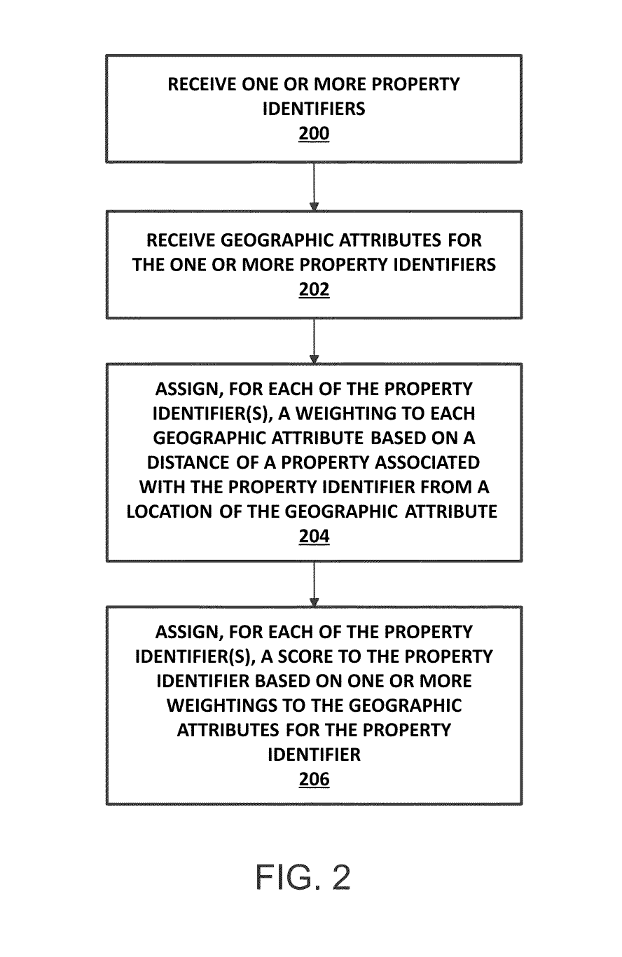

FIG. 2 illustrates a flowchart of an example method for processing modifiable files grouped into themed directories for presentation of web contents in accordance with embodiments of the present invention. The method is described in this example as being implemented by the web server 102, although it should be understood that the method may be implemented by one or more suitable computing devices.

Referring to FIG. 2, the method includes receiving 200 one or more property identifiers. In the example of FIG. 1, a user of the computing device 104 may interact with a user interface of the computing device 104. The user interface may present a web browser for entry of property identifiers. The entered property identifiers may subsequently be communicated to the web server 102. For example, property identifiers may be identifiers for one or more of houses, condominiums, townhouses, apartments, commercial properties, and/or the like. The identifiers may include, but are not limited to, prices, property sizes, features, and the like. The web server manager 108 may receive the property identifiers and store the property identifiers in memory 110.

The method of FIG. 2 also includes receiving 202 geographic attributes for the one or more property identifiers. Continuing the aforementioned example, the web browser presented by the user interface provide for entry of geographic attributes. The entered geographic attributes may subsequently be communicated to the web server 102. For example, geographic attributes may be attributes for one or more of shopping amenities, dining amenities, children amenities, family amenities, pet amenities, art-culture amenities, healthcare amenities, enrichment amenities, and/or the like. The attributes may include, but are not limited to, prices, property sizes, features, and the like.

The web server manager 108 may receive the property identifiers and store the property identifiers in memory 110. In accordance with embodiments, the communication of the property identifiers and geographic attributes to the web server 102 may be considered an inquiry from the user of the computing device 104. The web server 102 may receive an inquiry from a user for one of the property identifiers. Further, the web server manager 108 may generate a score associated with the property identifier and present the score to the user via the Internet 106. For example, the score may be communicated to the computing device 104 and presented to the user via the user interface of the computing device 104.

The method of FIG. 2 includes assigning 204, for each of the property identifier(s), a weighting to each geographic attribute based on a distance of a property associated with the property identifier from a location of the geographic attribute. Continuing the aforementioned example, the web server manager 108 may assign each geographic attribute a weight based on a distance of a property associated with the property identifier from the location of the geographic attribute. For example, the closer a grocery store, the higher a weighting given to that geographic attribute for the property identifier. Such weightings may be assigned to multiple geographic attributes.

The method of FIG. 2 assigning 206, for each of the property identifier(s), a score to the property identifier based on one or more weightings to the geographic attributes for the property identifier. Continuing the aforementioned example, the web server manager 108 may assign, for each property identifier, a score to the property identifier based on one or more weights to the geographic attributes for the property identifier. The score may be communicated to the computing device 104 for presentation to the user.

In an example usage, twenty-six (26) geographic attributes are associated with each property using different aggregated scores. Each aggregated score may be made up of a combination of one or more such attributes. An example list of different geographic attributes and their dependent aggregated score follow:
Malls, Grocery stores, Gas stations ->shopping score
Restaurants, Coffee shops, Bars ->Fine Dining Score
Home with kids, parks, schools, Day-care, Libraries ->Kids friendly Score
Pets store ->Pets-friendly Score
Theater, Opera-house, Dance-studio, museums, concert ->Art-culture culture
Hospital, Pharmacy , Surgical, Diagnostic Center, Urgent Care, Clinics ->Health-Care Score
Music, Tutors, Martial Arts ->Enrichment Activity Score
   For each property, a count is provided of all the geographic attributes on the left for different radius value. For example, this may be a number of malls within 1 mile, 3 miles, 5 miles, or 9 miles from given property. Below mentioned is the algorithm to compute the aggregated score on right side.

An example scoring algorithm follows:
(1) Get all the unique cities for all properties.
(2) For each city from A, perform following:
   (i) Get all properties, and for each property perform (ii) to (iii)
   (ii) Get all 26 attributes, and for each attribute, perform step (a)-(d):
      (a) Calculate the weighted score. The weighted score can depend on number of all entities under consideration. For example, to compute weighted mall score, the number of malls within 1 mile, 3 miles, 5 miles, and 9 miles may be used, and the weighted mall score for that property may be computed.
      b) Find the median for all the properties with respect to attribute under consideration.
      (c) Find standard deviation for all the properties with respect to attribute under consideration
      (d) Compute the final score on the scale of 0-100 for the attribute under consideration.
   (iii) For each property to get aggregated score, the process may include computing the average of the scores computed in step (d) for all the attributes that could be considered as a part of this aggregated score (refer to the above table). For example, to compute shopping score, malls, gas stations, and grocery stores may be the attributes that are considered.

The presently disclosed subject matter may consider the properties in the given city to compute the deviation and median. This can give more accurate aggregated score of the property compared to other properties in the same city and not whole nation.

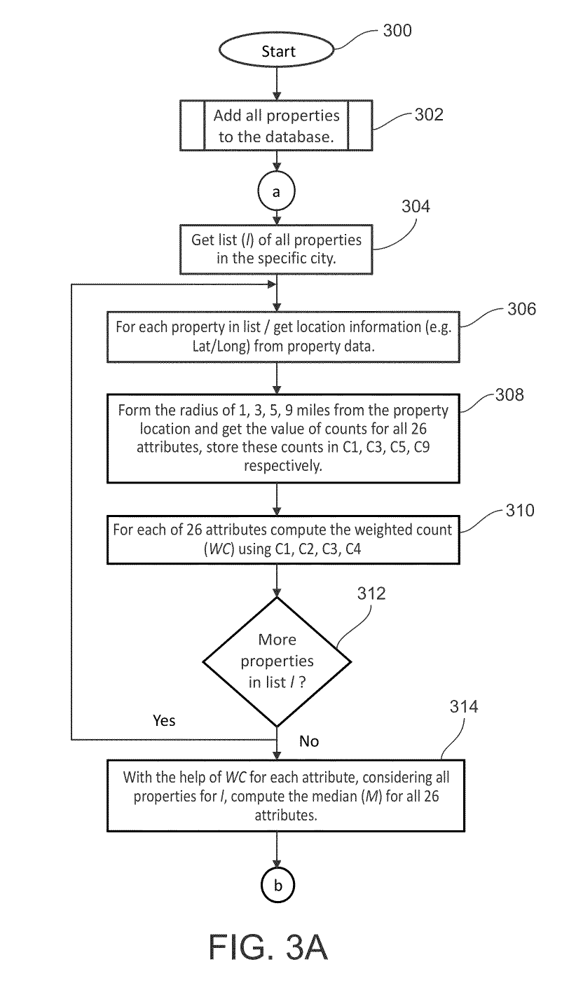

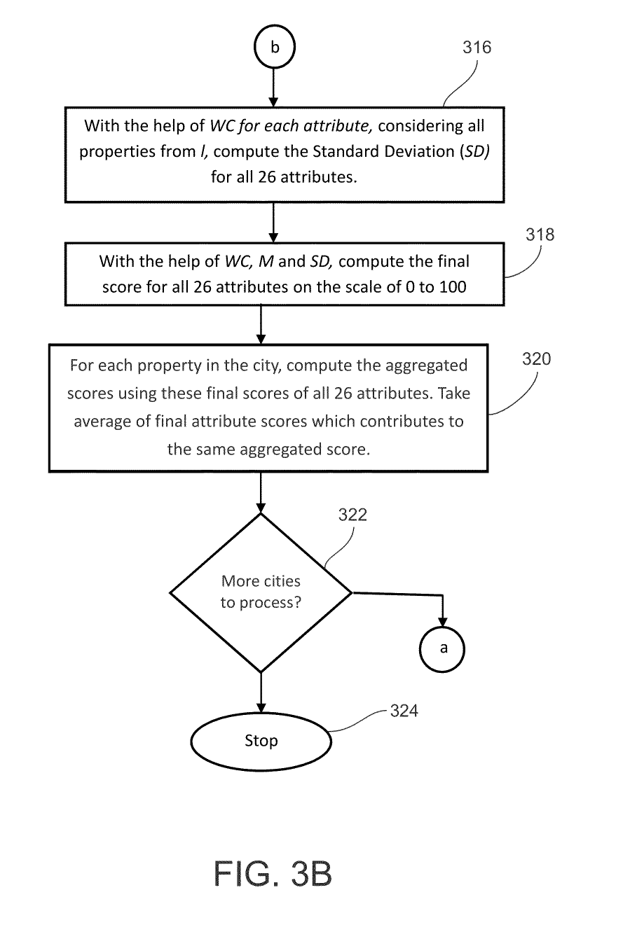

FIGS. 3A and 3B illustrate a flowchart of an example method for organizing a database in accordance with embodiments of the presently disclosed subject matter. It should be understood that the method may be implemented by the web server manager 108 shown in FIG. 1 or any other suitable component or system. Referring to FIGS. 3A and 3B, the method may start 300 and subsequently add 302 all properties to a database. For example, data for all searchable properties may be stored in the memory 110 shown in FIG. 1.

Continuing with FIGS. 3A and 3B, the method includes getting 304 a list (1) of all properties in a specific city or other geographic region. For each property in the list 1, the method includes getting 306 location information (e.g. latitude and longitude, or the like) from the property data. Subsequently, the method include forming 308 a radius of 1, 3, 5, and 9 miles from the property location and getting the value of counts for all 26 geographic attributes. Further, these counts can be stored in counts C1, C3, C5, and C9 for the 1, 3, 5, and 9 mile radiuses, respectively. For each of the 26 attributes, the weight count (WC) can be computed 310 using counts C1, C3, C5, and C9. Subsequently, the method determines 312 whether more properties are in list 1, and the loop of steps 306, 308, and 310 continues until all properties in the list 1 are processed. The method proceeds to step 314 after processing all properties in the list 1.

At step 314, the method includes computing, for all properties from list 1, the median (M) for all 26 attributes using the WC for each attribute. Further, the method includes computing 316, using all properties from list 1, the standard deviation (SD) for all 26 attributes with the use of the WC for each attribute. The method also includes computing 318 the final score for all 26 attributes on a scale of 0 to 100 using the WC. For each property in the city, the method includes computing 320 the aggregated scores using these final scores of all 26 attributes. Further, step 320 includes taking the average of final attribute scores which contributes to the same aggregated score. Subsequently, the method includes determining 322 whether there are additional cities to process. The method continues the look at block a until all cities are processed. Otherwise, the method stops 324.

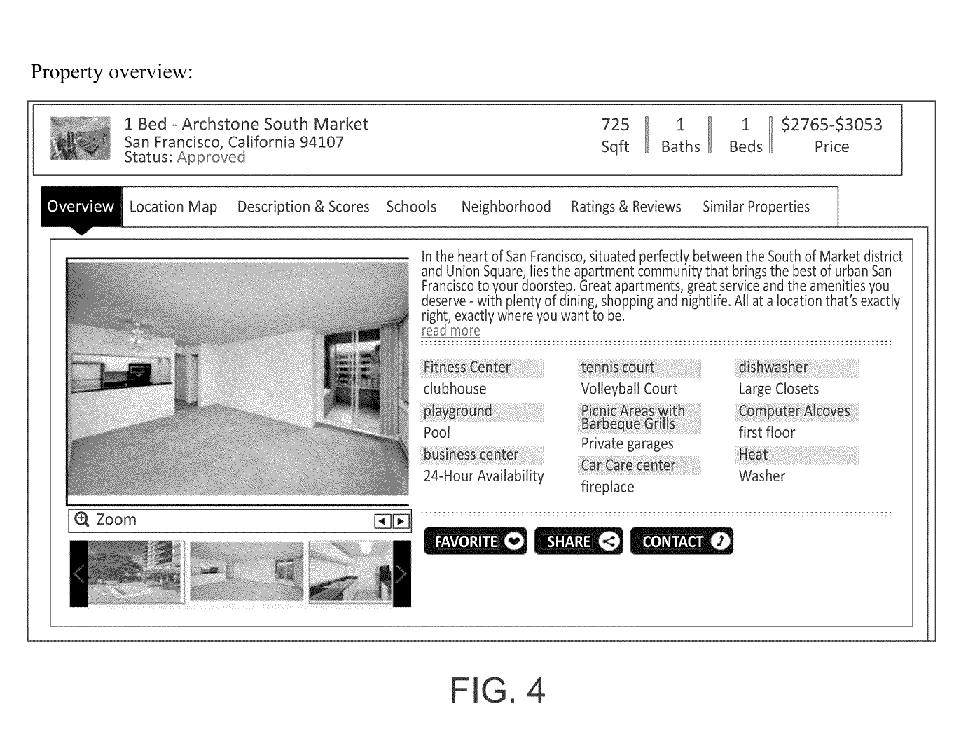

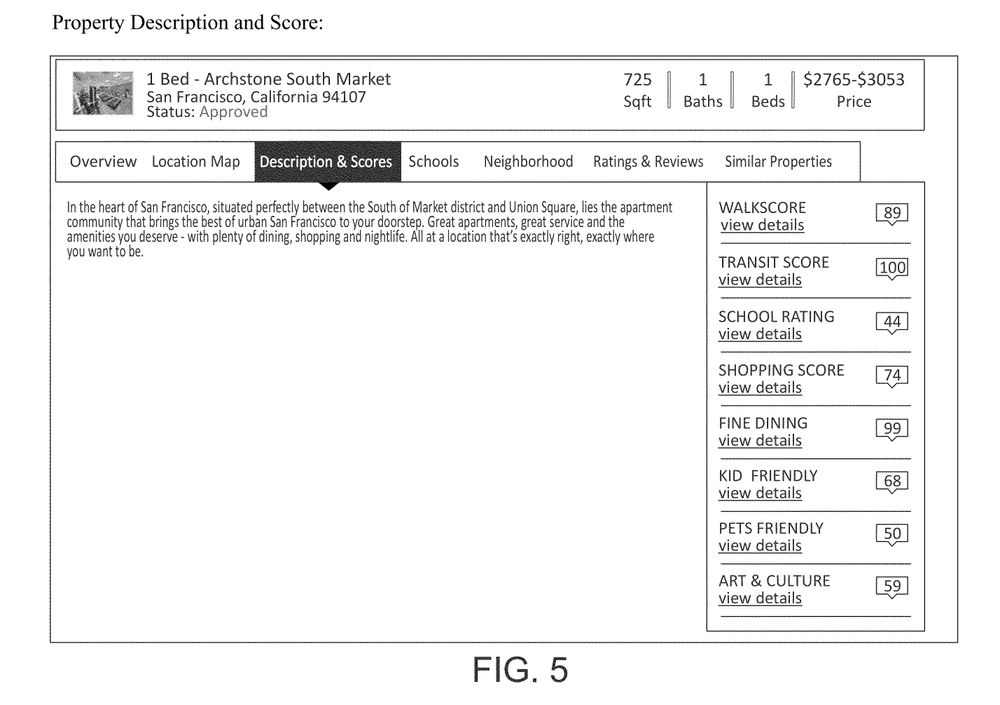

FIGS. 4 and 5 illustrate screen displays showing example information and images corresponding to a property identifier in accordance with embodiments of the present subject matter. Referring to FIG. 4, the screen display shows general information about a residence for rent between $2765 and $3065 per month. The screen display of FIG. 5 shows scores for multiple geographic attributes.

In accordance with embodiments, a system and method may provide a density index for all known latitude/longitudes within several countries for different venues (e.g., shopping malls, grocery stores, hospitals, parks, pet stores) for a given latitude/longitude. The density index can be used to evaluate latitudes and longitudes for a property's suitability for certain lifestyles. For example, high density scores for amenities such as restaurants, shopping malls, museums, opera houses, and the like may be indicative of a location that facilitates easier access to arts and culture. Consequently, if arts and culture were an important factor in a person's lifestyle, these locations would be an automatic choice.

A database in accordance with embodiments of the present subject matter may include all or many venues in several countries, such as the United States. This data contains details about venues like its name, category and sub category, address information, and the like.

In an example usage, when an address is input into the system, the address' corresponding latitude and longitude may be extracted. Subsequently, a density index may be determined for that location across various categories to establish a singular (1-100) score for each lifestyle criteria. In an embodiment, a method may include selecting all venues of different categories for a given score in a given city and state. Subsequently, the method may include computing a weighted count for all venues. Computation of the weighted count may include: selecting all venues within 1 mile, 3miles, 5 miles, and 9 miles from given venue and are similar to given venue; and computing a weighted count for given venue using the output. These computation steps may be repeated for all venues in the given city.

Next, the mean and standard deviation may be computed for a given city, for a given score. Further, the score of the venue may be calculated based on its weighted-count, and the mean and standard deviation previously calculated. These steps may be repeated for all venues within the given city.

When new property to be scored is added to the database, all venues within 1 mile radius from that property may be fetched. Their respective scores may be average to get the scores for the property.

It is noted that if no venues for any score are found in a 1 mile radius, then the radius is increased by 1 mile, and the average score is reduced by 5% as a premium factor. This step continues until all venues are found. If no venue is found within 10 miles, then the score value is set to 0 for that particular property and that particular score.

The various techniques described herein may be implemented with hardware or software or, where appropriate, with a combination of both. Thus, the methods and apparatus of the disclosed embodiments, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the presently disclosed subject matter. In the case of program code execution on programmable computers, the computer will generally include a processor, a storage medium readable by the processor (including volatile and non-volatile memory and/or storage elements), at least one input device and at least one output device. One or more programs may be implemented in a high level procedural or object oriented programming language to communicate with a computer system. However, the program(s) can be implemented in assembly or machine language, if desired. In any case, the language may be a compiled or interpreted language, and combined with hardware implementations.

The described methods and apparatus may also be embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, a video recorder or the like, the machine becomes an apparatus for practicing the presently disclosed subject matter. When implemented on a general-purpose processor, the program code combines with the processor to provide a unique apparatus that operates to perform the processing of the presently disclosed subject matter.

Features from one embodiment or aspect may be combined with features from any other embodiment or aspect in any appropriate combination. For example, any individual or collective features of method aspects or embodiments may be applied to apparatus, system, product, or component aspects of embodiments and vice versa.

While the embodiments have been described in connection with the various embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed:

1. A method comprising:
at a processor and memory:
receiving one or more property identifiers;
receiving geographic attributes for the one or more property identifiers; and
for each of the one or more property identifiers:
assigning a weighting to each geographic attribute based on a distance of a property associated with the property identifier from a location of the geographic attribute; and
assigning a score to the property identifier based on one or more weightings to the geographic attributes for the property identifier.

2. The method of claim 1, wherein the one or more property identifiers are associated with one or more of houses, condominiums, townhouses, apartments, and commercial properties.

3. The method of claim 1, wherein the geographic attributes include one or more of shopping amenities, dining amenities, children amenities, family amenities, pet amenities, art-culture amenities, healthcare amenities, and enrichment amenities.

4. The method of claim 1, further comprising determining, for each of the one or more property identifiers, the distance of the property associated with the property identifier from the location of the geographic attribute.

5. The method of claim 1, further comprising:
receiving an inquiry from a user for one of the property identifiers; and
presenting, to the user, the score associated with the one of the property identifiers.

6. The method of claim 5, further comprising using the Internet to receive the inquiry and to present the score to the user.

7. A system comprising:
at least one memory and processor configured to:
receive one or more property identifiers;
receive geographic attributes for the one or more property identifiers; and
for each of the one or more property identifiers:
assign a weighting to each geographic attribute based on a distance of a property associated with the property identifier from a location of the geographic attribute; and
assign a score to the property identifier based on one or more weightings to the geographic attributes for the property identifier.

8. The system of claim 7, wherein the one or more property identifiers are associated with one or more of houses, condominiums, townhouses, apartments, and commercial properties.

9. The system of claim 7, wherein the geographic attributes include one or more of shopping amenities, dining amenities, children amenities, family amenities, pet amenities, art-culture amenities, healthcare amenities, and enrichment amenities.

10. The system of claim 7, wherein the at least a memory and processor is configured to determine, for each of the one or more property identifiers, the distance of the property associated with the property identifier from the location of the geographic attribute.

11. The system of claim 7, wherein the at least a memory and processor is configured to:
receive an inquiry from a user for one of the property identifiers; and
present, to the user, the score associated with the one of the property identifiers.

12. The system of claim 11, wherein the at least a memory and processor is configured to use the Internet to receive the inquiry and to present the score to the user.

13. A computer program product comprising:
a computer readable storage medium having computer readable program code embodied therewith, the computer readable program code comprising:
computer readable program code configured to receive one or more property identifiers;
computer readable program code configured to receive geographic attributes for the one or more property identifiers; and
computer readable program code configured to assign, for each of the one or more property identifiers, a weighting to each geographic attribute based on a distance of a property associated with the property identifier from a location of the geographic attribute; and
computer readable program code configured to assign, for each of the one or more property identifiers, a score to the property identifier based on one or more weightings to the geographic attributes for the property identifier.

14. The computer program product of claim 13, wherein the one or more property identifiers are associated with one or more of houses, condominiums, townhouses, apartments, and commercial properties.

15. The computer program product of claim 13, wherein the geographic attributes include one or more of shopping amenities, dining amenities, children amenities, family amenities, pet amenities, art-culture amenities, healthcare amenities, and enrichment amenities.

16. The computer program product of claim 13, further comprising computer readable program code configured to determine, for each of the one or more property identifiers, the distance of the property associated with the property identifier from the location of the geographic attribute.

17. The computer program product of claim 13, further comprising computer readable program code configured to:
receive an inquiry from a user for one of the property identifiers; and
present, to the user, the score associated with the one of the property identifiers.

18. The computer program product of claim 17, further comprising computer readable program code configured to use the Internet to receive the inquiry and to present the score to the user.
